(19) United States
(12) Patent Application Publication
(10) Pub. No.: US 2004/0039785 A1
(43) Pub. Date: Feb. 26, 2004

(54) Method and system for distributing public service information

(76) Inventor: Ernest Garfield, Scottsdale, AZ (US)

Correspondence Address: WEISS & MOY PC, 4204 NORTH BROWN AVENUE, SCOTTSDALE, AZ, 85251, US

(21) Appl. No.: 10/463,925

(22) Filed: Jun. 18, 2003

Related U.S. Application Data
(60) Provisional application No. 60/402,276, filed on Aug. 9, 2002.

(51) Int. Cl. G06F 15/16

(52) U.S. Cl. 709/207

(57) ABSTRACT

A system and method of distributing public service announcements collects a list of email addresses; prepares an email message with hyperlink to a featured law enforcement web site; narrows the list of email addresses by selecting a geographical area to where the email message will be distributed; and sends email to selected email addresses in selected geographical area.

### RELATED APPLICATIONS

This patent application is claiming the benefit of the U.S. Provisional Application having an application number of 60/402,276, filed Aug. 9, 2002, in the name of Ernest Garfield, and entitled “METHOD AND SYSTEM FOR DISTRIBUTING PUBLIC SERVICE INFORMATION”.

### BACKGROUND OF THE INVENTION

1. Field of the Invention

This invention relates to public service information, and more specifically, to an improved system and method for distributing public service information.

2. Description of the Prior Art

Many public service agencies or authorities, e.g., law enforcement agencies, disaster prevention agencies, health agencies, weather services, land and forest management agencies, commerce and business agencies, etc., have web sites to distribute information. If members of the public want to access these agencies' web sites they must first know one exists for these agencies and then search for it. E-mail is often used by these agencies to communicate intra-agency, inter-agencies, with the media and other special interests. However, the general public is, for the most part, left out of the public service communications loop, and more often than not, is not aware of the myriad of agency websites. The eyes and ears of the general public has not previously been effectively used in obtaining information for public service authorities, e.g., fire agencies, weather agencies, law enforcement agencies and others. Moreover, these public service agencies have conventionally only relied on broadcast news media and literature distribution to disseminate requests for information and/or warnings concerning relevant public service information.

Therefore a need existed to provide an improved system and method for distributing public service information. The system and method must overcome the above shortcomings. The system and method must overcome the above shortcomings and others by providing targeted message distribution for public service information.

### SUMMARY OF THE INVENTION

In accordance with one embodiment of the present invention, it is an object of the present invention to provide an improved system and method for distributing public service information.

It is another object of the present invention to provide an improved system and method for distributing public service information that overcomes the problems associated with the prior art.

It is still another object of the present invention to provide an improved system and method that overcomes the problems associated with the prior art and others by providing targeted message distribution for public service information.

### BRIEF DESCRIPTION OF THE PREFERRED EMBODIMENTS

In accordance with one embodiment of the present invention a method of distributing public service announcements is disclosed. The method comprises: collecting a list of email addresses; preparing an email message with hyperlink to a featured law enforcement web site; narrowing the list of email addresses by selecting a geographical area to where the email message will be distributed; and sending email to selected email addresses in selected geographical area.

In accordance with another embodiment of the present invention a system of distributing public service announcements via email is disclosed. The system has a first server for collecting a list of email addresses wherein the first server is coupled to a plurality of additional servers to collect a list of email addresses from existing email service providers in order to compile a subscription based email address list wherein each individual email address will designate type of email to be received and location where owner of the individual email address is located. An input device is provided for preparing an email message with a hyperlink to a featured law enforcement web site and for narrowing the list of email addresses by selecting a geographical area to where the email message will be distributed. The first server is further used for sending the email message to selected email addresses in the selected geographical area.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a simplified functional block diagram of the system of the present invention

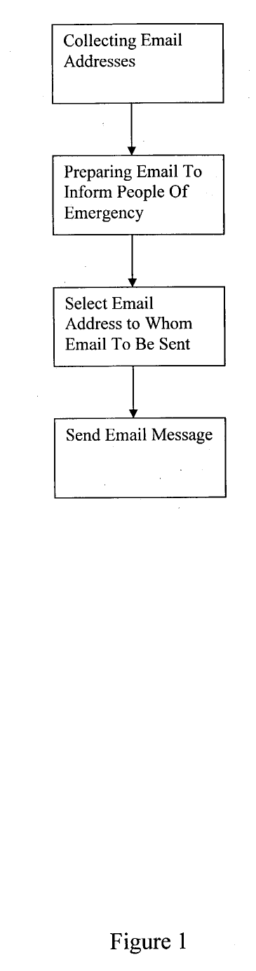

FIG. 2 is a flow chart showing the method of the present invention.

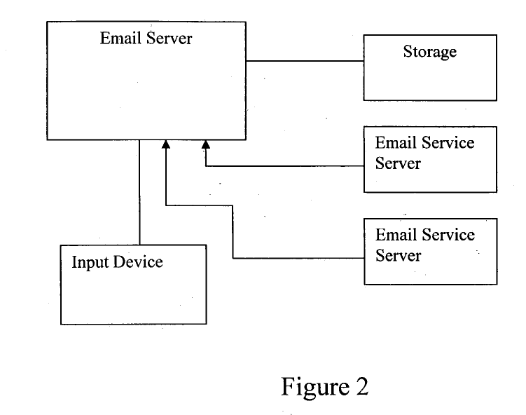

### DETAILED DESCRIPTION OF THE PREFERRED EMBODIMENT

The methods and systems disclosed herein greatly utilize the Internet as a tool for public service authorities by using solicited and unsolicited commercial e-mail. An example of the methods and systems will now be described in reference to law enforcement but is equally applicable to other types of public service agencies and information.

For public communications bureau for law enforcement agencies, this system and method may be referred to herein as “Crime Alert,” “Criminal Tracker,” “Terrorist Watch,” or “Neighborhood Watch.” This system and method integrates email and targeted information distribution as a standard tool for law enforcement to enlist the aid of the public in hunting down criminals, solving crimes and tracing missing people. This process enables law enforcement agencies to contact and mobilize members of the public, via the Internet email, for emergency or routine reasons.

In one embodiment, this system will send law enforcement information, web site links or e-mail crime alerts, including pictures, graphics and/or audio, to targeted members of the public. This information may be targeted to specific Internet users by zip code area, or by broader regions such as city, county, state, or nationally or internationally using geocoding or geographical information database techniques.

The magnitude of crime alert exposure to the public is immense, and the dynamics for increased interaction between citizens and law enforcement are immeasurable. One Internet connected computer or system may send 3 to 5 million messages during a 24-hour period. Contrast this to the 2 million hits monthly that the Federal Bureau of Investigation Web site receives. Many of the FBI Web site hits are by other law enforcement agencies rather than the public. In any event, the general public in an area of concern, e.g., escaped convict, or know armed felon, could not be relied upon to know about the possibility of the dangerous condition based on visits to the FBI website. Rather a Crime Alert message would be sent to users and email addresses classified in that geographical area to be on alert and/or report any pertinent information.

The Crime Alert method disclosed herein can be used to send information to, and request information from, hundreds of thousand Internet users in a give area of interest or nationally or internationally. An example message may warn recipients of specific terrorists' threats and/or include hyper-links to the FBI Web site pages of the Most Wanted Terrorists and Ten Most Wanted Fugitives or pages of wanted criminals that may be in the area. The inventive methods and systems may send those pages and others, e.g., the FBI Kidnaping and Missing Persons Investigations page directly rather than relying on e-mail recipients to take the extra step of using the hyper-links embedded in the message.

A. Crime Alert:

This type of alert would routinely and systematically send e-mails with links to pages, or pages, of the most wanted terrorists and fugitives and of missing children that are listed on law enforcement Web sites. The links will be to those specific pages of the Web sites of federal and state law enforcement agencies, county sheriffs, police departments of the largest 100 cities, as well as college and university police departments. The messages may be tailored specifically for certain regions, states, counties, cities or neighborhoods, depending on the subject matter relevant to that location.

B. High Crime Alert

A High Crime Alert would be specifically composed messages sent using intense e-mail saturation, and initiated only upon specific instructions from a law enforcement agency. The initiating agency will create the public message to send about criminal suspects, fugitives or victims, and specify the geographic area or region to be covered.

The region may be a Zip Code area, or international in size. In addition, or alternatively, the High Crime Alert message can be directed to specific professions or business designations. The law enforcement's emergency message, including audio, video and graphics, can be delivered to the receiving device, e.g., computer, of every Internet user with a known address, e.g., an address stored in a database and preferably addresses verified to accept this type of email by the user.

This message distribution program will enhance law enforcement and other agencies' use of media to help solve crimes. In one embodiment of the system, a centralized mail distribution service is utilized by the public service agencies to send and receive messages, store and/or verify address and maintain the technical and create aspects of the message distribution. In this manner, the service may be able to track how many messages are opened, the time spent reviewing each letter and the pages reviewed, etc. If desired, the service may report these statistics to the respective public service agencies that contract with the service, so that they may be informed as to the effectiveness of their messages.

### Method for Applying Crime Alert & High Crime Alert Systems

I. Crime Alert:

1.Select law enforcement agencies to feature.

2.Prepare e-mail message with hyperlink to the featured law enforcement Web site, or set up message to be an actual page from the Web site.

3. Select the geographic area (from precompiled geographical database of addresses) and volume to be mailed.

4. Enter e-mail message and Internet addresses into a software program with its own mailing component.

5. Send e-mail.

The Crime Alert method may be enabled to send messages 24-hours a day, 7-days a week on a rotational basis for as many law enforcement agencies that register with the service provider. In one embodiment of the invention, the service provider also hosts its own website with a directory of links to the most wanted criminals and missing people pages of all major U.S. law enforcement agencies and the most populous 250 counties and 100 cities.

II. High Crime Alert:

1. Notification of need for High Crime Alert is received from law enforcement agency.

2. Agency provides message, including graphics, audio and video, to be sent and the region to be covered.

3. Enter e-mail message and Internet addresses into a software program with its own mailing component.

4. Send e-mail.

The High Crime Alert message is deployed at the specific request of a law enforcement agency.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method of distributing public service announcements comprising:
collecting a list of email addresses;
preparing an email message with hyperlink to a featured law enforcement web site;
narrowing the list of email addresses by selecting a geographical area to where the email message will be distributed; and
sending email to selected email addresses in selected geographical area.

2. The method of claim 1 wherein collecting a list of email addresses comprises compiling a subscription based email address list wherein each individual email address will designate type of email to be received and location where owner of the individual email address is located.

3. The method of claim 1 wherein collecting a list of email addresses comprises collecting email addresses from existing email service providers.

4. The method of claim 3 further comprising allowing individual owners of the collected email address to designate type of email to be received and indicate location where owner of the individual email address is located.

5. The method of claim 1 wherein preparing an email message further comprises coupling an attachment to the email message.

6. The method of claim 5 wherein the attachment is a text attachment.

7. The method of claim 5 wherein the attachment is a audio attachment.

8. The method of claim 5 wherein the attachment is a video attachment.

9. The method of claim 5 wherein the attachment is a graphical attachment.

10. The method of claim 1 wherein narrowing the list of email addresses by selecting a geographical area to where the email message will be distributed further comprises narrowing the list of email addresses by state.

11. The method of claim 1 wherein narrowing the list of email addresses by selecting a geographical area to where the email message will be distributed further comprises narrowing the list of email addresses by zip code.

12. A method of distributing public service announcements comprising:
collecting a list of email addresses from existing email service providers and compiling a subscription based email address list wherein each individual email address will designate type of email to be received and location where owner of the individual email address is located;
preparing an email message with hyperlink to a featured law enforcement web site;
narrowing the list of email addresses by selecting a geographical area to where the email message will be distributed; and
sending email to selected email addresses in selected geographical area.

13. The method of claim 12 wherein preparing an email message further comprises coupling an attachment to the email message.

14. The method of claim 12 wherein narrowing the list of email addresses by selecting a geographical area to where the email message will be distributed further comprises narrowing the list of email addresses by state.

15. The method of claim 12 wherein narrowing the list of email addresses by selecting a geographical area to where the email message will be distributed further comprises narrowing the list of email addresses by zip code.

16. A system of distributing public service announcements via email comprising:
a first server for collecting a list of email addresses wherein the first server is coupled to a plurality of additional servers to collect a list of email addresses from existing email service providers to compiling a subscription based email address list wherein each individual email address will designate type of email to be received and location where owner of the individual email address is located; and
input device for preparing an email message with a hyperlink to a featured law enforcement web site and for narrowing the list of email addresses by selecting a geographical area to where the email message will be distributed.
wherein the first server is used for sending the email message to selected email addresses in the selected geographical area.

17. The system of claim 16 wherein the input device is further used for coupling an attachment to the email message.
